(19) United States
(12) Patent Application Publication
(10) Pub. No.: US 2022/0322393 A1
(43) Pub. Date: Oct. 6, 2022

(54) USER EQUIPMENT AND METHOD FOR UPLINK TRANSMISSION

(71) Applicant: FG Innovation Company Limited, Tuen Mun (HK)

(72) Inventors: CHIA-HUNG LIN, Taipei (TW); CHIA-HAO YU, Taipei (TW); WAN-CHEN LIN, Taipei (TW)

(21) Appl. No.: 17/711,334

(22) Filed: Apr. 1, 2022

Related U.S. Application Data
(60) Provisional application No. 63/169,732, filed on Apr. 1, 2021.

(51) Int. Cl. H04W 72/12; H04L 5/00

(52) U.S. Cl. CPC H04W 72/1268; H04L 5/0051; H04W 72/1289

(57) ABSTRACT

A user equipment (UE) and a method for uplink (UL) transmission are provided. The method includes receiving, from a base station (BS), a first Radio Resource Control (RRC) configuration that indicates a first Sounding Reference Signal (SRS) resource set and a second SRS resource set; receiving, from the BS, Downlink Control Information (DCI) comprising at least a specific field; and determining whether to apply both or only one of the first SRS resource set and the second SRS resource set during Physical Uplink Shared Channel (PUSCH) transmission according to the specific field.

### CROSS-REFERENCE TO RELATED APPLICATION(S)

The present disclosure claims the benefit of and priority to U.S. Provisional Patent Application Ser. No. 63/169,732, filed on Apr. 1, 2021, entitled “MECHANISMS FOR SUPPORTING DYNAMIC SWITCHING BETWEEN S-TRP AND MULTI-TRP BASED TRANSMISSION,” the content of which is hereby incorporated fully by reference into the present disclosure for all purposes.

### FIELD

The present disclosure is related to wireless communication, and more specifically, to user equipment and method for UL transmission in cellular wireless communication networks.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

Abbreviations used in this disclosure include:

Abbreviation Full name

3GPP 3r^{d} Generation Partnership Project p 5G 5^{th} Generation

ACK Acknowledgment

BS Base Station

BWP Bandwidth Part

C-RNTI Cell Radio Network Temporary Identifier

CA Carrier Aggregation

CG Configured Grant

CRC Cyclic Redundancy Check

CS-RNTI Configured Scheduling Radio Network Temporary Identifier

CSI-RS Channel State Information Reference Signal

DC Dual Connectivity

DCI Downlink Control Information

DL Downlink

DMRS Demodulation Reference Signal

E-UTRA Evolved Universal Terrestrial Radio Access

FR Frequency Range

HARQ Hybrid Automatic Repeat Request

HARQ-ACK HARQ Acknowledgement

ID Identifier

IE Information Element

LTE Long Term Evolution

MAC Medium Access Control

MAC CE MAC Control Element

MCG Master Cell Group

MCS Modulation Coding Scheme

MN Master Node

NR New Radio

NW Network

OFDM Orthogonal Frequency Division Multiplexing

PCell Primary Cell

PDCCH Physical Downlink Control Channel

PDSCH Physical Downlink Shared Channel

PHY Physical (layer)

PRACH Physical Random Access Channel

PUCCH Physical Uplink Control Channel

PUSCH Physical Uplink Shared Channel

RA Random Access

RAN Radio Access Network

Rel Release

RI Rank Indicator

RF Radio Frequency

RNTI Radio Network Temporary Identifier

RRC Radio Resource Control

RRH Remote Radio Head

RS Reference Signal

SCell Secondary Cell

SCG Secondary Cell Group

SN Secondary Node

SRI SRS Resource Indicator

SRS Sounding Reference Signal

TB Transport Block

TPC Transmission Power Control

TPMI Transmit Precoding Matrix Indicator

TRP Transmission Reception Point

TS Technical Specification

Tx Transmission

UE User Equipment

UL Uplink

URLLC Ultra-Reliable and Low-Latency Communication

### SUMMARY

The present disclosure is related to a UE and a method for UL transmission in cellular wireless communication networks.

In a first aspect of the present application, a method for UL transmission performed by a UE is provided. The method includes receiving, from a BS, a first RRC configuration that indicates a first SRS resource set and a second SRS resource set; receiving, from the BS, DCI comprising at least a specific field; and determining whether to apply both or only one of the first SRS resource set and the second SRS resource set during PUSCH transmission according to the specific field.

In an implementation of the first aspect, the method further includes determining an order in which the first SRS resource set and the second SRS resource set are applied according to the specific field in a case that both of the first SRS resource set and the second SRS resource set are applied during the PUSCH transmission.

In another implementation of the first aspect, the first SRS resource set is associated with a first TRP of the BS; and the second SRS resource set is associated with a second TRP of the BS.

In another implementation of the first aspect, the PUSCH transmission is scheduled by the DCI.

In another implementation of the first aspect, CRC of the DCI is scrambled by a CS-RNTI.

In another implementation of the first aspect, the method further includes receiving, from the BS, a second RRC configuration that indicates a first power control related parameter associated with the first SRS resource set and a second power control related parameter associated with the second SRS resource set; and activating the PUSCH transmission along with the second RRC configuration upon reception of the DCI.

In another implementation of the first aspect, the number of first SRS resources in the first SRS resource set is identical to the number of second SRS resources in the second SRS resource set.

In another implementation of the first aspect, the DCI further includes a first TPMI field and a second TPMI field; the first TPMI field indicates first precoding information when applying the first SRS resource set during the PUSCH transmission; and the second TPMI field indicates second precoding information when applying the second SRS resource set during the PUSCH transmission.

In another implementation of the first aspect, a same number of layers of precoding matrix is applied to the first TPMI field and the second TPMI field; and first candidate TPMI values corresponding to the first TPMI field and second candidate TPMI values corresponding to the second TPMI field are based on a same TPMI table.

In another implementation of the first aspect, the second TPMI field has fewer bits than the first TPMI field.

In a second aspect, a UE for UL transmission is provided. The UE includes one or more processors and at least one memory coupled to at least one of the one or more processors, where the at least one memory stores a computer-executable program that, when executed by the at least one of the one or more processors, causes the UE to receive, from a BS, a first RRC configuration that indicates a first SRS resource set and a second SRS resource set; receive, from the BS, DCI comprising at least a specific field; and determine whether to apply both or only one of the first SRS resource set and the second SRS resource set during PUSCH transmission according to the specific field.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a codebook (CB)-based UL transmission procedure in NR, according to an example implementation of the present disclosure.

FIG. 2 illustrates a non-CB based UL transmission procedure in NR, according to an example implementation of the present disclosure.

FIG. 3 illustrates a system in which a UE performs multi-TRP based PUSCH transmission, according to an example implementation of the present disclosure.

FIG. 4A is a diagram illustrating a multi-TRP based PUSCH transmission enabled with repetitive transmission, according to an example implementation of the present disclosure.

FIG. 4B is a diagram illustrating a multi-TRP based PUSCH transmission enabled with repetitive transmission, according to another example implementation of the present disclosure.

FIG. 5 is a flowchart illustrating a method/process performed by a UE for UL transmission, according to an example implementation of the present disclosure.

FIG. 6 is a block diagram illustrating a node for wireless communication, according to an example implementation of the present disclosure.

### DESCRIPTION

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include computer executable instructions stored on a computer readable medium such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), comprising of the SpCell and optionally one or more Secondary Cells (SCells). An SCG may refer to a group of serving cells associated with the Secondary Node (SN), comprising of the SpCell and optionally one or more SCells.

As previously disclosed, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate and low latency requirements. The Orthogonal Frequency-Division Multiplexing (OFDM) technology in the 3 GPP may serve as a baseline for an NR waveform. The scalable OFDM numerology such as adaptive sub-carrier spacing, channel bandwidth, and Cyclic Prefix (CP) may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Examples of some selected terms are provided as follows.

RNTI: RNTIs are used to differentiate/identify a connected UE in the cell, a specific radio channel, a group of UEs in case of paging, a group of UEs for which power control is issued by the gNB, and/or system information transmitted for all the UEs by 5G gNB.

Antenna Panel: is a conceptual term for UE antenna implementation. It may be assumed that a panel is an operational unit for controlling a transmission spatial filter (beam). A panel is typically consisted of a plurality of antenna elements. In one implementation, a beam may be formed by a panel and in order to form two beams simultaneously, two panels may be needed. Such simultaneous beamforming from multiple panels is subject to UE capability. A similar definition for “panel” may be possible by applying spatial receiving filtering characteristics.

Beam: the terms “beam” and “spatial filter” may be used interchangeably in this disclosure. For example, when a UE reports to a preferred gNB a Tx beam, the UE is essentially selecting a spatial filter used by the gNB. The term “beam information” is used to provide information about which beam/spatial filter is being used/selected. In one example, individual reference signals are transmitted by applying individual beams (spatial filters). Thus, the term “beam” or “beam information” may be represented by reference signal resource index(es).

DCI: DCI stands for downlink control information and there are various DCI formats used in the PDCCH. The DCI format is a predefined format in which the downlink control information is packed/formed and transmitted in the PDCCH.

HARQ: is a functionality that ensures delivery between peer entities at Layer 1 (e.g., PHY Layer). A single HARQ process may support one TB when the PHY layer is not configured for DL/UL spatial multiplexing. A single HARQ process may support one or multiple TBs when the PHY layer is configured for DL/UL spatial multiplexing. There may be one HARQ entity per serving cell. Each HARQ entity may support parallel processing of (e.g., multiple) DL and UL HARQ processes.

In the 3GPP Rel-16 NR, multi-TRP based PDSCH repetition is applied for, e.g., URLLC purpose. The reliability of PDSCH transmission under multi-TRP scenario is enhanced by PDSCH repetition. Based on the development of PDSCH enhancement in multi-TRP, the enhancement of other physical channels (e.g., PUSCH, PDCCH, PUCCH) is to be discussed in the 3GPP Rel-17.

For PUSCH, two types of transmission modes are supported in NR, namely codebook (CB) based and non-codebook (non-CB) based transmissions. CB-based UL transmission has been developed for several years in commercial communication systems, e.g., wideband code division multiple access (WCDMA), LTE, and NR. Basically, the operation of CB-based UL transmission depends on the NW indications on transmission parameters. For example, transmit rank indication (TRI) and TPMI are frequently adopted as signaling content. Both TRI and TPMI may be associated with a set of SRS resources, which are used for channel sounding. In NR, since there is possibility of having multiple sets of SRS resources, an SRI field may be indicated by the BS to indicate an SRS resource set with which TRI and/or TPMI is associated.

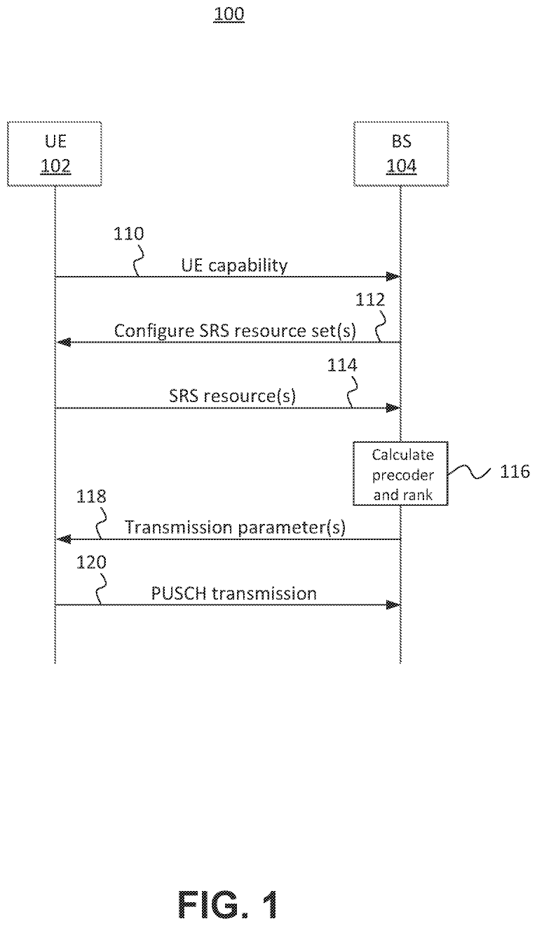

FIG. 1 illustrates a codebook (CB)-based UL transmission procedure 100 in NR, according to an example implementation of the present disclosure. In action 110, UE 102 may report UE capability (or UE's capability) to BS 104 (e.g., a gNB). In action 112, BS 104 may configure one or multiple SRS resource set(s) to UE 102 based on the UE capability. In action 114, UE 102 may transmit SRS resource(s) to BS 104 according to the configured SRS resource set(s). In action 116, BS 104 may calculate precoder and rank based on the received SRS resource(s) (and other factors). In action 118, BS 104 may transmit transmission parameter(s) to UE 102 (e.g., via DCI). For example, the DCI may be a scheduling DCI, and the transmission parameters may include RI, TPMI and/or SRS resource indicator (SRI). In action 120, UE 102 may perform PUSCH transmission based on the transmission parameters received in action 118.

Different from CB-based PUSCH transmission, for non-CB based PUSCH transmission, the UE may determine its PUSCH precoder and transmission rank based on SRS resource indicator (SRI) directly. SRI may be given by DCI or a higher layer parameter (e.g., srs-ResourceIndicator). For training the PUSCH precoder, usage of an SRS resource set may be set to “noncodebook” for such a purpose. The UE may test some candidate precoders by non-CB SRS resource transmission. The UE may derive the candidate precoders based on DL measurements on an associated Non-Zero Power (NZP) CSI-RS.

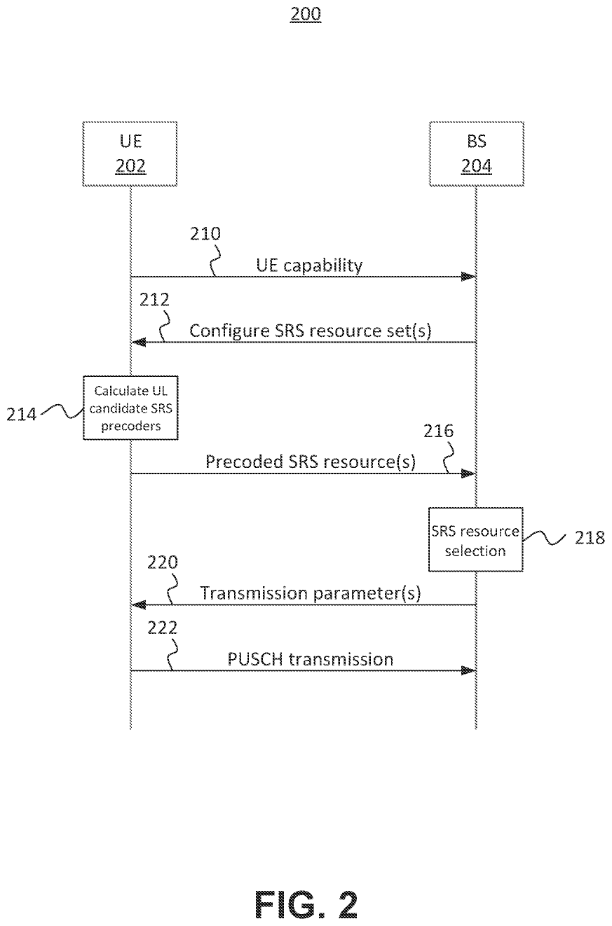

FIG. 2 illustrates a non-CB based UL transmission procedure 200 in NR, according to an example implementation of the present disclosure. In action 210, UE 202 may report UE capability on non-CB based PUSCH transmission to BS 204 (e.g., a gNB). In action 212, BS 204 may configure one or multiple non-CB SRS resource set(s) to UE 202 based on the UE capability. In action 214, UE 202 may calculate UL candidate SRS precoders. In action 216, UE 202 may transmit precoded SRS resource(s) to BS 204. In action 218, BS 204 may perform SRS resource selection based on the received SRS resource(s). In action 220, BS 204 may provide transmission parameter(s) to UE 202 (e.g., via DCI and/or an RRC parameter, such as ConfiguredGrantConfig). For example, the DCI may be a scheduling DCI. The RRC parameter(s) may be included in an RRC configuration for configured grant, such as a CG configuration. The transmission parameters may include SRI and/or DMRS port indicator. In action 222, UE 202 may perform PUSCH transmission based on the transmission parameters received in action 220.

PUSCH enhancement in a multi-TRP scenario for URLLC services will be discussed in Rel-17 NR. Similar to the PDSCH enhancement in Rel-16, the Rel-17 PUSCH enhancement may also utilize repetition mechanisms to increase the transmission reliability, with different repetitions targeting at different TRPs. For these repetition mechanisms, most of the transmission parameters (e.g., TPMI, MCS, TPC, SRI and so on) are carried in a single scheduling DCI for informing the UE how to perform transmission for the individual repetitions. For a Rel-16 CB-based PUSCH transmission, a TPMI and a UL beam associated with the TPMI, indicated by a scheduling DCI, may be applied. For a Rel-16 non-CB based PUSCH transmission, after the UE transmits multiple SRSs with different spatial properties (e.g., precoders), the BS (e.g., gNB) may indicate to the UE the desired precoder(s) and rank by selecting a subset of the multiple SRSs, and may inform the UE of the subset (e.g., via the PDCCH).

In addition, close-loop power control may be performed irrespective of CB or non-CB based PUSCH transmission. The power of PUSCH transmission may be adjusted by the TPC field carried in the PDCCH. In a multi-TRP scenario, different TRPs may be located on different geographic areas. Multiple sets of transmission parameters may be indicated to the UE for repetitive PUSCH transmission since different transmission parameters for PUSCH transmission may be applied to different TRPs.

Under some scenarios, performing multi-TRP based PUSCH transmission may not be feasible. For example, a channel condition between a UE and one of the TRPs to which the UE transmits the PUSCH may not be good enough to justify the usage of additional transmission resource(s). Hence, efficient adaptation (e.g., dynamic switching) between the single-TRP based PUSCH transmission and multi-TRP based PUSCH transmission is beneficial and will be addressed in the present disclosure.

In the present disclosure, mechanisms for supporting dynamic switching between a single-TRP based PUSCH transmission and a multi-TRP based PUSCH transmission are disclosed. In some implementations, the mechanisms for dynamic switching may be achieved via one or more fields received from a base station (e.g., carried in the DCI). Existing fields (e.g., SRI, TPMI, TPC) or a dedicated field (e.g., a new field used to indicate the dynamic switching between a single-TRP based PUSCH transmission and a multi-TRP based PUSCH transmission) may be used to perform the dynamic switching between the single-TRP based PUSCH transmission and multi-TRP based PUSCH transmission. In some implementations, the PUSCH may be further enabled with repetitive transmission.

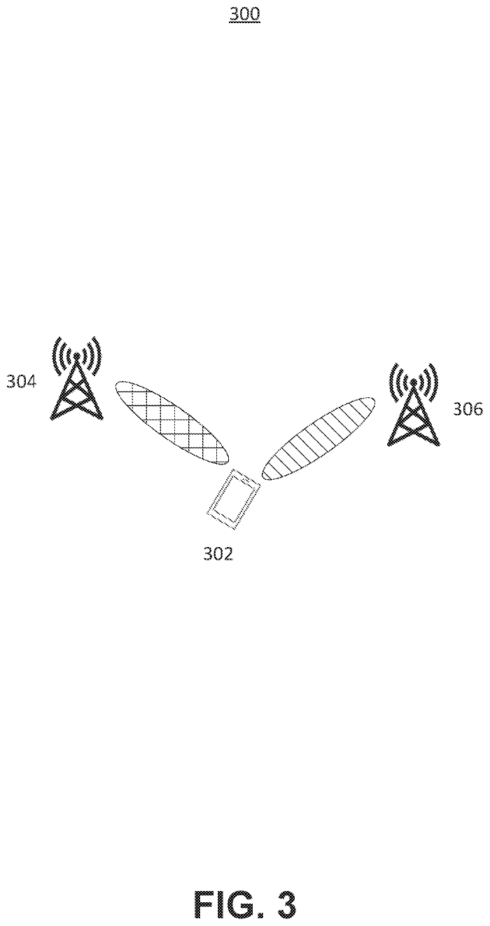

FIG. 3 illustrates a system 300 in which a UE performs multi-TRP based PUSCH transmission, according to an example implementation of the present disclosure. UE 302 may be connected to multiple TRPs, including TRP 304 and TRP 306. In some implementations, TRP 304 and TRP 306 may be associated with the same BS. For example, TRP 304 and TRP 306 may correspond to different remote radio heads (RRHs) of a BS. In some implementations, TRP 304 may be associated with a first SRS resource set configured by the BS, and TRP 306 may be associated with a second SRS resource set configured by the BS. In some implementations, TRP 304 and TRP 306 may correspond to two different base stations. For multi-TRP based PUSCH transmission in system 300, UE 302 may utilize a repetition mechanism and alternate UL transmission between TRP 304 and TRP 306. For example, in some implementations, UE 302 may perform PUSCH transmission in an order of {TRP 304, TRP 306, TRP 304, TRP 306, . . . }. In some other implementations, UE 302 may perform PUSCH transmission in an order of {TRP 304, TRP 304, TRP 306, TRP 306, . . . }.

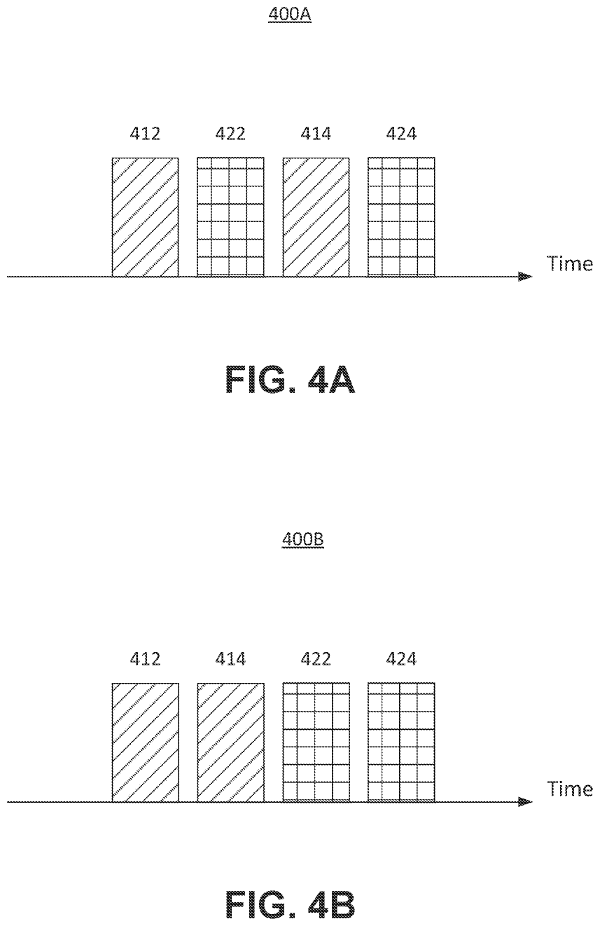

FIG. 4A is a diagram 400A illustrating a multi-TRP based PUSCH transmission enabled with repetitive transmission, according to an example implementation of the present disclosure. PUSCH transmissions 412 and 414 may correspond to a first TRP (e.g., TRP #1, or TRP 304 shown in FIG. 3). PUSCH transmissions 422 and 424 may correspond to a second (different) TRP (e.g., TRP #2, or TRP 306 shown in FIG. 3). A UE may apply a first SRS resource set during PUSCH transmissions 412 and 414 and apply a second SRS resource set during PUSCH transmissions 422 and 424. The UE may perform PUSCH transmissions, which is enabled with repetition, in an order of {TRP #1, TRP #2, TRP #1, TRP #2}. FIG. 4B is a diagram 400B illustrating a multi-TRP based PUSCH transmission enabled with repetitive transmission, according to another example implementation of the present disclosure. In this example implementation, the UE may perform PUSCH transmissions, which is enabled with repetition, in an order of {TRP #1, TRP #1, TRP #2, TRP #2}.

The resources (e.g., time and frequency) for PUSCH transmissions 412, 414, 422, and 424 may be determined by a UL grant, which may be a dynamic grant or a configured grant. In a case of a dynamic grant, the DCI that schedules PUSCH transmissions 412, 414, 422, and 424, which may also be referred to as the scheduling DCI, may include different transmission parameters, such as TPMI #1, SRI #1, and power #1 that are associated with TRP #1, and TPMI #2, SRI #2, and power #2 that are associated with TRP #2. The DCI may include a DCI format with CRC scrambled by a C-RNTI. In a case of a configured grant (CG) type 1, a CG configuration transmitted via RRC signaling may include transmission parameters, such as TPMI #1, SRI #1, power #1, TPMI #2, SRI #2, power #2, and periodicity. In a case of a CG type 2, in some implementations, a CG configuration transmitted via RRC signaling may include a periodicity that defines a period of PUSCH transmission, and the DCI addressed to a CS-RNTI may activate the configured uplink grant. The DCI may include transmission parameters, such as TPMI #1, SRI #1, power #1, TPMI #2, SRI #2, and power #2. In a case of a CG type 2, in some implementations, a CG configuration transmitted via RRC signaling may include a periodicity that defines a period of PUSCH transmission and transmission parameters, such as TPMI #1, SRI #1, power #1, TPMI #2, SRI #2, and power #2. The DCI addressed to a CS-RNTI may activate the configured uplink grant along with the CG configuration.

In the present disclosure, the DCI that includes one or more fields for indicating multi-TRP/single-TRP based PUSCH transmissions may include a DCI format with CRC scrambled a C-RNTI (the dynamic grant scenario) or a DCI format with CRC scrambled a CS-RNTI (e.g., the CG type 2 scenario).

When not specifically stated, RRC parameters or special terms mentioned in the present disclosure may refer to 3GPP TS 38.211 V16.4.0, TS 38.212 V16.4.0, TS 38.213 V16.4.0, TS 38.214 V16.4.0, TS 38.321 V16.3.0, TS 38.331 V16.3.0.

### SRI Field Used For Switching Indication

In order to support multi-TRP based PUSCH transmission, there may be two SRI fields included in the DCI. The two SRI fields may indicate to a UE the SRI values that correspond to different TRPs, such as SRI #1 for TRP #1 and SRI #2 for TRP #2. In some implementations, TRP #1 and TRP #2 may be associated with the same BS, where TRP #1 may be associated with a first SRS resource set configured by the BS, and TRP #2 may be associated with a second SRS resource set configured by the BS. In some implementations, when performing multi-TRP based PUSCH transmission, the number of SRS resources configured in the two SRS resource sets may be the same. That is, the number of first SRS resources in the first SRS resource set may be identical to the number of second SRS resources in the second SRS resource set. Therefore, the bit length of the two SRI field may be the same.

In some implementations, one of the SRI fields may indicate to the UE, in addition to the SRI values, whether to switch to a single-TRP based PUSCH transmission. In some implementations, an SRI field may be directly used to indicate whether to perform switching between the single-TRP based PUSCH transmission and multi-TRP based PUSCH transmission. An SRI table may not have an empty entry under some conditions. Hence, the SRI field may not have reserved bit/value to indicate whether to perform switching between the single-TRP based PUSCH transmission and multi-TRP based PUSCH transmission. Under such conditions, the bit length of the SRI field used to provide switching indication between the single-TRP based PUSCH transmission and multi-TRP based PUSCH transmission may be increased, for example, by one bit. In some implementations, the one bit may be attached to the SRI field to provide the switching indication.

In some implementations, multiple SRI fields may be included in the DCI to support multi-TRP based transmission. To support dynamic switching between the single-TRP based PUSCH transmission and multi-TRP based transmission and/or dynamically switching the transmitting order of TRPs to which a UE transmits the repetitive PUSCH, one of the SRI fields may be associated with a new SRI table. The new SRI table may provide, in addition to the SRI values, an indication of the switching between the single-TRP based PUSCH transmission and multi-TRP based PUSCH transmission and/or the transmitting order of TRPs to which the UE transmits the repetitive PUSCH.

In some implementations, one of the SRI fields used for the repetitive PUSCH transmissions to the different TRPs may further indicate whether to switch from a multi-TRP based PUSCH transmission to a single-TRP based PUSCH transmission. Furthermore, one of the SRI fields used for the repetitive PUSCH transmissions to the TRPs may indicate to which TRP a UE may target its PUSCH repetition first.

In some implementations, two SRI fields may be used to support multi-TRP based PUSCH transmission. The contents of the SRI field used to provide the switching indication and/or transmission order change indication of the TRPs may be referred to an SRI table that is generated based on the SRI table associated with the other SRI field that is only used to provide the SRI values.

Table 1 below illustrates an SRI indication for codebook based PUSCH transmission, according to an example implementation of the present disclosure. In some implementations, two SRI fields may be used to support multi-TRP based PUSCH transmission. For the codebook based PUSCH transmission, in a case that ul-FullPowerTransmission=fullpowerMode2 and the number of SRS resources configured in an SRS resource set is 3 (e.g., N_{SRS}=3), Table 1 may be used to support dynamic switching between the single-TRP based PUSCH transmission and multi-TRP based PUSCH transmission.

TABLE 1
SRI indication for codebook-based PUSCH
transmission, if ul-FullPowerTransmission =
fullpowerMode2 and N_{SRS} = 3

| Bit field mapped to index | SRI(s), N_{SRS} = 3 |
|---|---|
| 0 | 0 |
| 1 | 1 |
| 2 | 2 |
| 3 | Switch to single-TRP transmission |

In some implementations, two SRI fields may use the same SRI table, and one of the SRI fields may be used to provide the SRI value and the switching indication. For example, one of the SRI fields may be used to provide the switching indication in addition to the SRI value. In some implementations, if the SRI field shows ‘11’, it may indicate to a UE to switch to a single-TRP based PUSCH transmission. In some implementations, the UE may expect only one of the SRI fields to include the value (e.g., “11”) in the DCI. In some implementations, the UE may expect one specific SRI field to have the value, but not the other one. For example, the UE may expect a second SRI field to signal the value “11”, but not the first SRI field. In some implementations, if the switching indication is received from a specific SRI field, the UE may stop the PUSCH repetitions to a TRP that corresponds to the specific SRI field. In some implementations, if the switching indication is received from a specific SRI field, the UE may direct the PUSCH repetitions to the TRP(s) other than the TRP corresponding to the specific SRI field.

Table 2 below illustrates an SRI indication for non-codebook based PUSCH transmission, according to an example implementation of the present disclosure. In some implementations, two SRI fields may be used to support multi-TRP based PUSCH transmission. The two SRI fields may be associated with the same SRI table, and one SRI field may be used to provide an SRI value and the switching indication. For example, one of the SRI fields may be used to provide the switching indication in addition to the SRI value. For the non-codebook based PUSCH transmission, Table 2 may represent the SRI field used to provide the switching indication. In a case that the maximum number of layers for PUSCH is 2 (e.g., Lₘₐₓ=2), Table 2 may be used to support dynamic switching between the single-TRP based PUSCH transmission and multi-TRP based PUSCH transmission.

TABLE 2
SRI indication for non-codebook based
PUSCH transmission, Lₘₐₓ = 2

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | Switch to | 3 | 0, 1 | 3 | 3 |
| | single-TRP | | | | |
| | transmission | | | | |
| | | 4 | 0, 2 | 4 | 0, 1 |
| | | 5 | 1, 2 | 5 | 0, 2 |
| | | 6 | Switch to | 6 | 0, 3 |
| | | | single-TRP | | |
| | | | transmission | | |
| | | 7 | Reserved | 6 | 1, 2 |
| | | | | 7 | 1, 3 |
| | | | | 9 | 2, 3 |
| | | | | 10 | Switch to |
| | | | | | single-TRP |
| | | | | | transmission |
| | | | | 11-15 | Reserved |

In some implementations, based on the above illustrated table, if the SRI field include the value ‘11’ when N_{SRS}=2 (or shows ‘110’ when N_{SRS}=3, or ‘1010’ when N_{SRS}=4, and so on), it may indicate to a UE to switch to a single-TRP based PUSCH transmission. In some implementations, the UE may expect only one of the SRI fields to signal such switching indication in DCI. In some implementations, the UE may expect such a switching indication from one specific SRI field, but not from the other SRI field. For example, the UE may expect such a switching indication from a second SRI field, but not from a first SRI field in the DCI. In some implementations, if the switching indication is received from a specific SRI field, the UE may stop the PUSCH repetitions to the TRP that corresponds to the specific SRI field. In some implementations, if the switching indication is received from a specific SRI field, the UE may direct the PUSCH repetitions to the TRP(s) other than the TRP that corresponds to the specific SRI field.

In some implementations, the SRI table associated with the SRI fields used for codebook based or non-codebook based PUSCH transmission may not include empty entries (e.g., reserved values). In some implementations, a UE may not expect to perform the switching between the single-TRP based PUSCH transmission and multi-TRP based transmission. In some implementations, the network may implicitly inform the UE that the UE does not need to perform the switching between a single-TRP and a multi-TRP based PUSCH transmission.

In some implementations, the SRI table may indicate that there might be some empty entries (e.g., reserved values) for the switching indication. Table 3 below illustrates an SRI indication for codebook based PUSCH transmission according to an example implementation of the present disclosure. As shown in Table 3, the SRI table may be enhanced by adding two empty entries (e.g., by adding one to the bit width of the SRI field for the switching indication). One of the empty entries may be used to provide the switching indication.

TABLE 3
SRI indication for codebook based PUSCH transmission,
if ul-FullPowerTransmission is not configured, or ul-
FullPowerTransmission = fullpowerMode1, or ul-
FullPowerTransmission = fullpowerMode2, or ul-
FullPowerTransmission = fullpower and N_{SRS} = 2

| Bit field mapped to index | SRI(s), N_{SRS} = 2 |
|---|---|
| 0 | 0 |
| 1 | 1 |
| 2 | Switch to single-TRP |
| | transmission |
| 3 | Reserved |

In some implementations, only one SRS source may be configured to each of the SRS resource sets that are applied to PUSCH transmissions (e.g., to the different TRPs). In some implementations, the SRI field for providing the switching indication may not be absent. For example, there might be two SRI fields, including SRI field #0 and SRI field #1, that are applied for repetitive PUSCH transmissions to different TRPs. SRI field#1 may also provide the switching indication. Under this scenario, when only one SRS source is configured to each of the SRS resource sets, SRI field #0 may be absent, but SRI field #1 that is used for providing the switching indication may not be absent. In some implementations, one bit may indicate the switching between a single-TRP based PUSCH transmission and a multi-TRP based PUSCH transmission. In some implementations, the bit may further indicate the transmission order of the TRPs. In some implementations, if the bit is ‘0’, a UE may be indicated to switch to a single-TRP based PUSCH transmission. If the bit is ‘1’, the UE may be indicated to switch the transmission order of the TRPs. In some implementations, if a field in the DCI indicates the switching of the transmission order, the corresponding TRP for starting the PUSCH repetitive transmission may change from a first TRP to a second TRP.

### TPMI Field Used For Switching Indication

In order to support multi-TRP based PUSCH transmission, there may be two TPMI fields included in the DCI. The two TPMI fields may indicate to a UE the spatial precoders corresponding to the different TRPs, such as TPMI #1 for TRP #1 and TPMI #2 for TRP #2. TPMI #1 may indicate the first precoding information when the UE applies a first SRS resource set associated with TRP #1. TPMI #2 may indicate the second precoding information when the UE applies a second SRS resource set associated with TRP #2.

In some implementations, when performing multi-TRP based PUSCH transmission, the same number of layers of precoding matrix may be applied to the two TPMI fields. TPMI values of the two TPMI fields may be selected from the same TPMI table. For example, the first candidate TPMI values corresponding to TPMI #1 and the second candidate TPMI values corresponding to TPMI #2 may be derived based on the same TPMI table. One of the TPMI fields may further indicate whether to perform the switching between a single-TRP based PUSCH transmission and a multi-TRP based PUSCH transmission. The TPMI table may not have an empty entry under some conditions, and therefore the TPMI field may not have reserved bit/value for indicating whether to perform the switching between a single-TRP based PUSCH transmission and a multi-TRP based PUSCH transmission. Under such conditions, the bit width of the TPMI field for providing the switching indication between the single-TRP based PUSCH transmission and multi-TRP based PUSCH transmission may be increased by one bit. For example, one bit may be attached to the TPMI field for providing the switching indication.

In some implementations, one of the TPMI fields used for the repetitive PUSCH transmissions to the different TRPs may indicate whether to switch between the multi-TRP based PUSCH transmission and single-TRP based PUSCH transmission. In some implementations, one of the TPMI fields used for the repetitive PUSCH transmissions to the different TRPs may further indicate to which TRP the PUSCH repetitions should be started.

In some implementations, two TPMI fields may be used to support multi-TRP based PUSCH transmission. The contents of the TPMI field used to provide the switching indication or/and transmission order change indication of the TRP may be referred to a TPMI table that is generated based on the TPMI table associated with the other TPMI field that is only used to provide the TPMI values.

Table 4 below illustrates the precoding information and the number of layers for two antenna ports, according to an example implementation of the present disclosure. In some implementations, two TPMI fields may be used to support multi-TRP based PUSCH transmission, including TPMI #0 and TPMI #1. Between the two TPMI fields, one TPMI field may be used to provide a switching indication. For example, Table 4 may be applied to TPMI #0 to provide a TPMI value. The bit width of TPMI #1 may be related to the number of layers selected in TPMI #0. As such, TPMI #1 may have fewer bits than TPMI #0. More specifically, if codebookSubset is fullyAndPartialAndNonCoherent and the number of layers indicated in TPMI #0 is N (e.g., N is 1 or 2), the bit width of TPMI #1 may be ┌log₂(x)┐, where x may be the total number of the options based on the TPMI table associated with TPMI #0 when the number of layers is N. For example, in Table 4 below, x is 2 (corresponding to index=0, 1) when N is 1 and the type of codebookSubset is noncoherent. In another example, in Table 4, x is 3 (corresponding to index=2, 7, 8) when N is 2 and codebookSubset is fullyAndPartialAndNonCoherent, and the bit width of TPMI #1 may be ┌log₂(3)┐=2. In TPMI #1, the values ‘00’ may represent ‘2 layers: TPMI=0’, ‘01’ may represent ‘2 layers: TPMI=1’, ‘10’ may represent ‘2 layers: TPMI=2’ and ‘11’ may be a reserved value. If the dynamic switching between the single-TRP based PUSCH transmission and multi-TRP based PUSCH transmission is supported, the value ‘11’ may indicate to a UE to switch to a single-TRP based PUSCH transmission.

TABLE 4
Precoding information and the number of layers for 2 antenna
ports, if transform precoder is disabled, maxRank =
2, and ul-FullPowerTransmission is not configured or configured
to fullpowerMode2 or configured to fullpower

| Bit field | | Bit field | |
|---|---|---|---|
| mapped | codebookSubset = | mapped | codebookSubset = |
| to index | fullyAndPartialAndNonCoherent | to index | noncoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

In some implementations, the number of layers for transmissions to different TRPs in a PUSCH repetitive transmission may be the same. In some implementations, a UE may expect the switching indication from one specific TPMI field, but not from the other TPMI field. For example, the UE may expect to receive the switching indication from a second TPMI field, but not from a first TPMI field in the DCI. In some implementations, if the switching indication is received from a specific TPMI field, the UE may stop the PUSCH repetitions to a TRP corresponding to the specific TPMI field. In some implementations, if the switching indication is received from a specific TPMI field, the UE may direct the PUSCH repetitions to the TRP(s) other than the TRP that corresponds to the specific TPMI field. In some implementations, if there are no reserved values in TPMI #1 for providing the switching indication, one bit may be attached to TPMI #1 for providing the switching indication. In some implementations, if the attached bit is ‘0’, the UE may be indicated to switch to a single-TRP based PUSCH transmission. If the attached bit is ‘1’, the UE may be indicated to switch the transmission order of TRPs.

In some implementations, two TPMI fields may be used to support multi-TRP based PUSCH transmission. Between the two TPMI fields, one TPMI field may be used to provide a switching indication. In some implementations, the same TPMI table (e.g., Table 4) may be applied to TPMI #0 and TPMI #1 to provide a TPMI value. In addition, TPMI #1 may be used to provide the switching indication. Under such a condition, the reserved value(s) included in Table 4 may be used to indicate the switching between a single-TRP based PUSCH transmission and a multi-TRP based PUSCH transmission and/or the transmission order of the TRP. For example, when the type of codebookSubset is fullyAndPartialAndNonCoherent, the value ‘1001’ may be used to indicate to a UE to switch to a single-TRP based PUSCH transmission. In addition, ‘1010’ may be used to indicate to the UE to switch the transmission order of TRPs.

In some implementations, the UE may expect only one of the TPMI fields to signal the switching indication in DCI. In some implementations, the UE may expect the switching indication from one specific TPMI field, but not from the other TPMI field. For example, the UE may expect the switching indication from a second TPMI field, but not from a first TPMI field in the DCI. In some implementations, if the switching indication is received from a specific TPMI field, the UE may stop the PUSCH repetitions to the TRP that corresponds to the specific TPMI field. In some implementations, if the switching indication is received from a specific TPMI field, the UE may direct the PUSCH repetitions to the TRP(s) other than the TRP corresponding to the specific TPMI field. However, if there are no reserved values in TPMI #1 for providing the switching indication, one bit may be attached to TPMI #1 for providing the switching indication. In some implementations, if the attached bit is ‘0’, the UE may be indicated to switch to a single-TRP based PUSCH transmission. If the attached bit is ‘1’, the UE may be indicated to switch the transmission order of TRPs.

### TPC Field Used For Switching Indication

In order to support multi-TRP based PUSCH transmission, there may be two TPC fields included in the DCI. The two TPC fields may be used to adjust the power level applied for different repetitive PUSCH transmissions to the different TRPs.

In some implementations, between the two TPC fields used to adjust the power level corresponding to the different TRPs, one TPC field may be further used to indicate whether to perform the switching between a single-TRP based PUSCH transmission and a multi-TRP based PUSCH transmission. Under some conditions, there may be no reserved bit/value in the TPC field for indicating whether to perform the switching between a single-TRP based PUSCH transmission and a multi-TRP based PUSCH transmission. Under such conditions, the bit width of the TPC field used to provide the switching indication between the single-TRP based PUSCH transmission and multi-TRP based PUSCH transmission may be increased by one bit. For example, one bit may be attached to the TPC field for providing the switching indication.

In some implementations, one of the TPC fields used for repetitive PUSCH transmissions to the different TRPs may indicate whether to switch between the multi-TRP based PUSCH transmission and single-TRP based PUSCH transmission. In some implementations, one of the TPC fields used for the repetitive PUSCH transmissions to the different TRPs may further indicate the transmission order of TRPs to which the UE should transmit the repetitive PUSCHs.

In some implementations, an extra bit may be attached to the TPC field to provide the switching indication between the single-TRP based PUSCH transmission and multi-TRP based PUSCH transmission. Specifically, the bit width of the TPC field may be increased to 3. Some values (e.g., ‘100’ and ‘101’) may be used to provide the switching indication and the transmission order of TRPs.

### Joint DCI Fields Used For The Switching Indication

To support multi-TRP based PUSCH transmission, multiple DCI fields (e.g., 2 SRI fields, 2 TPMI fields, 2 TPC fields) may be included in the DCI for providing the TRP-specific indication to a UE to transmit the repetitive PUSCH transmissions to the different TRPs. In some implementations, dynamic switching between the single-TRP based PUSCH transmission and multi-TRP based transmission may be performed via a single DCI field (e.g., the second SRI field, the second TPMI field, or the second TPC field) or multiple fields (e.g., a combination of the second SRI field and the second TPMI field).

For dynamic switching indication via a single DCI field, the switching indication may be included in an empty/reserved entry of an SRI table or a TPMI table used to provide the value for the SRI field or the TPMI field, respectively. For dynamic switching indication via multiple DCI fields, the switching indication may be included in an empty entry of the SRI table or the TPMI table used to provide the value for the SRI field and TPMI field, respectively, depending on whether there are empty entries in the SRI table or TPMI table. For example, if the SRI table used to provide the value of SRI field does not have any empty entry for the switching indication, the empty entries of the TPMI table may be used for the switching indication. In another example, if the TPMI table used to provide the value of TPMI field does not have any empty entry for the switching indication, the empty entries of the SRI table may be used for the switching indication.

In yet another example, if the TPMI table used to provide the value of TPMI field and the SRI table used to provide the value of SRI field do not have any empty/reserved entry for the switching indication, an extra bit may be attached to the SRI field and/or TPMI field for the switching indication. In a case that an extra bit is attached to the SRI field or the TPMI field, the attached bit may indicate the switching indication. For example, the attached bit having a value of ‘0’ may indicate to a UE to switch from the multi-TRP based PUSCH transmission to a single-TRP based PUSCH transmission. Conversely, the attached bit having a value of ‘1’ may indicate to the UE to keep performing multi-TRP based PUSCH transmissions. In a case that one extra bit is attached to the SRI field as well as the TPMI field, the attached bit in the SRI field or the TPMI field may be used to provide the switching indication. For example, the attached bit having a value of ‘0’ may indicate to the UE to switch from the multi-TRP based PUSCH transmission to a single-TRP based PUSCH transmission, and the attached bit having a value of ‘1’ may indicate to the UE to keep performing multi-TRP based PUSCH transmissions. The attached bit in the SRI field or the TPMI field may also be used to indicate a change in the transmission order of TRPs. For example, the attached bit having a value of ‘0’ may indicate to the UE to change the transmission order of TRPs, and the attached bit having a value of ‘1’ may indicate to the UE not to change the transmission order of TRPs.

In some implementations, any combination of SRI fields, TPMI fields, and TPC fields may be jointly used for providing the switching indication and/or transmission order of TRPs.

In some implementations, the SRI field and the TPMI field may be jointly used to indicate to a UE whether to switch to a single-TRP based PUSCH transmission. For example, assuming that there are two SRI fields and two TPMI fields included in the DCI to support multi-TRP based PUSCH transmissions.

Under such a scenario, in some implementations, if the SRI table associated with the second SRI field has empty entries (e.g., reserved values in the SRI table), the switching indication and/or the transmission order of TRPs may be provided in the second SRI field.

In some implementations, if the SRI table associated with the second SRI field does not have empty entries (e.g., reserved values in SRI table) and the TPMI table associated with the second TPMI field has empty entries (e.g., reserved values in TPMI table), the switching indication and/or the transmission order of TRPs may be provided in the second TPMI field.

In some implementations, if the second SRI field used to provide the switching indication is absent and the TPMI table associated with the second TPMI field has empty entries (e.g., reserved values in TPMI table), the switching indication and/or the transmission order of TRPs may be provided in the second TPMI field.

In some implementations, if neither the SRI table nor the TPMI table associated with the second SRI field and the second TPMI field has empty entries (e.g., reserved values in SRI table and TPMI table), the network may implicitly inform the UE that no switching between the single-TRP based PUSCH transmission and multi-TRP based PUSCH transmission is performed. In addition, the network may also implicitly inform the UE that the transmission order of TRPs is not changed.

In some implementations, if the second SRI field is absent and the TPMI table associated with the second TPMI field does not have empty entries (e.g., reserved values in TPMI table), the network may implicitly inform the UE that no switching between the single-TRP based PUSCH transmission and multi-TRP based PUSCH transmission is performed. In addition, the network may also implicitly inform the UE that the transmission order of TRPs is not changed.

In some implementations, if neither the SRI table nor the TPMI table associated with the second SRI field and the second TPMI field has empty entries (e.g., reserved values in SRI table and TPMI table), one bit may be attached to the SRI field to provide the switching indication. Specifically, if the attached bit is ‘0’, a UE may be indicated to switch to a single-TRP based PUSCH transmission. If the attached bit is ‘1’, the UE may be indicated to switch the transmission order of TRPs.

In some implementations, if the second SRI field is absent and the TPMI table associated with the second TPMI field does not have empty entries (e.g., reserved values in TPMI table), one bit may be attached to the TPMI field that is used to provide the switching indication. Specifically, if the attached bit is ‘0’, the UE may be indicated to switch to a single-TRP based PUSCH transmission. If the attached bit is ‘1’, the UE may be indicated to switch the transmission order of TRPs.

### A Dedicated Field Used For Switching Indication

To perform the dynamic switching between a single-TRP based PUSCH transmission and a multi-TRP based PUSCH transmission, the DCI may include a dedicated field (e.g., a new field added to the DCI) for the switching indication. Furthermore, the dedicated field may further indicate the transmission order of TRPs to which a UE transmits the PUSCHs.

In some implementations, the new field may be included in the DCI to indicate whether to perform the switching between a single-TRP based PUSCH transmission and a multi-TRP based PUSCH transmission. In addition, the new field may be used to indicate the transmission order of the different TRPs to which a UE transmits repetitive the PUSCHs. For example, the default setting of the transmission order of TRPs may be {TRP #0, TRP #1}. The UE may transmit the repetitive PUSCHs to TRP #0 first, and then transmit the repetitive PUSCHs to TRP #1 next. If the bit of the new field is ‘1’, the network may indicate to the UE that the transmission order of the TRPs is changed. For example, the transmission order of TRPs is changed from {TRP #0, TRP #1} to {TRP #1, TRP #0}. If the bit of the new field is ‘0’, the network may indicate to the UE that the transmission is changed to a single-TRP based PUSCH transmission. In another example, if the bit of the new field is ‘0’, the network may indicate to the UE that the transmission order of TRPs is changed. For example, the transmission order of TRPs is changed from {TRP #0, TRP #1} to {TRP #1, TRP #0}. If the bit of the new field is ‘1’, the network may indicate to the UE that the transmission is changed to a single-TRP based PUSCH transmission.

It should be noted that the examples listed herein are exemplary rather than limiting. For example, the number of bits in the new field may also be two in some implementations. Each possible value of the new field may have a different meaning in different implementations. The new field included in the DCI may indicate to the UE whether to perform a single-TRP based PUSCH transmission or a multi-TRP based PUSCH transmission. The new field may also indicate to the UE the transmission order of the multiple TRPs in a case that the UE performs the multi-TRP based PUSCH transmission.

In some implementations, the DCI including the field for the switching indication may be one of a DCI format 0_1, a DCI format 0_2, and a new DCI format for scheduling multi-TRP operation.

In some implementations, the switching indication may be a one-bit indication and the field for the switching indication may always exist when the UE performs multi-TRP based PUSCH transmission. For example, the switching indication having a value of ‘0’ may indicate switching to a single-TRP based PUSCH transmission, and a value of ‘1’ may indicate to keep performing the multi-TRP based PUSCH transmission.

In some implementations, the switching indication may be a two-bit indication and the field for the switching indication may always exist when the UE performs multi-TRP based PUSCH transmission. For example, the switching indication having a value of ‘00’ may indicate switching to a single-TRP based PUSCH transmission, a value of ‘01’ may indicate to keep performing multi-TRP based PUSCH transmission, a value of ‘10’ may indicate switching the transmission order of TRPs, and a value of ‘11’ may be a reserved value.

In some implementations, the field for the switching indication may be 1 bit or 0 bit (absent). If at least one of the second SRI field, the second TPMI field, and the second TPC field does not have a reserved value for the switching indication, the bit size of the field in the DCI used to provide the switching indication may be 1 bit. The field having a value of ‘0’ may indicate switching to a single-TRP based PUSCH transmission, and a value of ‘1’ may indicate to keep performing multi-TRP based PUSCH transmission. If at least one of the second SRI field, the second TPMI field, and the second TPC field does not have a reserved value for the switching indication, the bit size of the field in the DCI used to provide the switching indication may be 0 bit. The field for the switching indication in the DCI may be absent when the existing fields (e.g., SRI field, TPMI field or TPC field) have a reserved value to provide the switching indication. It should be noted that the DCI may have one of a DCI format 0_1, a DCI format 0_2, and a new DCI format for scheduling the multi-TRP operations.

In some implementations, the field for the switching indication may be 0, 1, or 2 bits. If at least one of the second SRI field, the second TPMI field, and the second TPC field does not have a reserved value for the switching indication, the bit size of the field in the DCI used to provide the switching indication may be 2. The field having a value of ‘00’ may indicate switching to a single-TRP based PUSCH transmission, a value of ‘01’ may indicate to keep performing multi-TRP based PUSCH transmission, a value of ‘10’ may indicate switching the transmission order of TRPs, and a value of ‘11’ may be a reserved value.

If at least one of the second SRI field, the second TPMI field, and the second TPC field has only one reserved value for the switching indication, the bit size of the field may be 1 bit. In addition, the one reserved value included in at least one of the SRI field, the TPMI field, and the TPC field may be used to provide the switching indication. The filed having a value of ‘0’ may indicate switching the transmission order of TRPs, and a value of ‘1’ may be a reserved value.

If at least one of the second SRI field, the second TPMI field, and the second TPC field have reserved values to indicate switching between the multi-TRP and single-TRP based PUSCH transmission and/or a change in the transmission order of TRPs, the bit size of the field for the switching indication may be 0 bit. The field for the switching indication may be absent when the existing fields (e.g., SRI field, TPMI field, and TPC field) have enough reserved values to provide the switching indication. It should be noted that the DCI may have one of a DCI format 0_1, a DCI format 0_2, and a new DCI format for scheduling the multi-TRP operations.

In some implementations, if a specific DCI format or a DCI format with CRC scrambled by a specific RNTI is configured, the PUSCH transmission scheduled by the specific DCI format may refer to a multi-TRP transmission. In other words, the DCI format may be used to switch the operation between the single-TRP and multi-TRP based transmission.

In some implementations, one new field may be included in an RRC message to provide the switching indication to a UE. If the UE receives the switching indication via the RRC message, the UE may switch to a single-TRP based PUSCH transmission at next PUSCH transmission.

In some implementations, when a UE is performing multi-TRP based PUSCH or CG PUSCH transmission, if the UE receives the switching indication in the RRC message, the UE may switch to a single-TRP based PUSCH/CG PUSCH transmission on the remaining UL grants configured for PUSCH/CG PUSCH transmission.

In some implementations, an RRC message that includes CG configurations or a PUSCH configuration may indicate multiple sets of parameters (e.g., power control related parameter, spatial precoding and so on) for multi-TRP based PUSCH/CG PUSCH transmission. The RRC message may indicate to the UE to switch to the single-TRP based PUSCH/CG PUSCH. The RRC message may indicate to the UE to select which set of parameters configured for multi-TRP based PUSCH/CG PUSCH transmission when performing a single-TRP based PUSCH/CG PUSCH transmission.

In some implementations, both CG configurations applied for single-TRP based PUSCH/CG PUSCH transmission and multi-TRP based PUSCH/CG PUSCH may be configured to a UE when indicating to the UE to perform multi-TRP based PUSCH/CG PUSCH transmission. When the UE receives an RRC message that indicates to the UE to switch to the single-TRP based PUSCH/CG PUSCH, the UE may perform a single-TRP based PUSCH/CG PUSCH transmission with the PUSCH/CG configuration applied for single-TRP based PUSCH/CG PUSCH transmission that has already been configured.

### Switching Between a Single-TRP Based PUSCH Transmission and a Multi-TRP Based PUSCH Transmission in CG PUSCH Transmission

To support multi-TRP based PUSCH transmission in CG based PUSCH transmission, an RRC message may include multiple fields (e.g., 2 precodingAndNumberOfLayers fields, 2 srs-ResoueceIndixator fields or 2 pathlossReferenceIndex fields) to provide multiple indications to a UE for transmitting the PUSCHs to the different TRPs. In some implementations, the IE rrc-ConfiguredUplinkGrant used to indicate uplink grant configuration to the UE for CG PUSCH transmission may include one field to also indicate the configured uplink grant is used for a single-TRP based PUSCH transmission or a multi-TRP based PUSCH transmission. In some implementations, some values of the existing field (e.g., 2 precodingAndNumberOfLayers fields, 2 srs-ResoueceIndixator fields or 2 pathlossReferenceIndex fields) included in the IE rrc-ConfiguredUplinkGrant may be used to indicate the configured uplink grant is used for a single-TRP based PUSCH transmission or a multi-TRP based PUSCH transmission. In some implementations, the UL grant may be activated by a DCI format 0_1 or a DCI format 0_2 with CRC scrambled by CS-RNTI. In addition, the DCI format 0_1 or DCI format 0_2 with CRC scrambled by CS-RNTI may also include one field to support the switching between a single-TRP based PUSCH transmission and a multi-TRP based PUSCH transmission.

In some implementations, the IE rrc-ConfiguredUplinkGrant used to indicate uplink grant configuration to a UE for CG PUSCH transmission may also include one field to indicate the configured uplink grant is used for the single-TRP based PUSCH transmission or multi-TRP based PUSCH transmission. The CG PUSCH may refer to Type 1 CG PUSCH and/or Type 2 CG PUSCH. In some implementations, some values of the existing field (e.g., 2 precodingAndNumberOfLayers fields, 2 srs-ResoueceIndixator fields or 2 pathlossReferenceIndex fields) included in the IE rrc-ConfiguredUplinkGrant may be used to indicate the configured uplink grant is used for a single-TRP based PUSCH transmission or a multi-TRP based PUSCH transmission. In some implementations, the UL grant is activated by DCI format 0_1, DCI format 0_2, or a new DCI format with CRC scrambled by a CS-RNTI. In addition, the DCI format 0_1, DCI format 0_2, or the new DCI format with CRC scrambled by the CS-RNTI may also include one field to support the switching between a single-TRP based PUSCH transmission and a multi-TRP based PUSCH transmission.

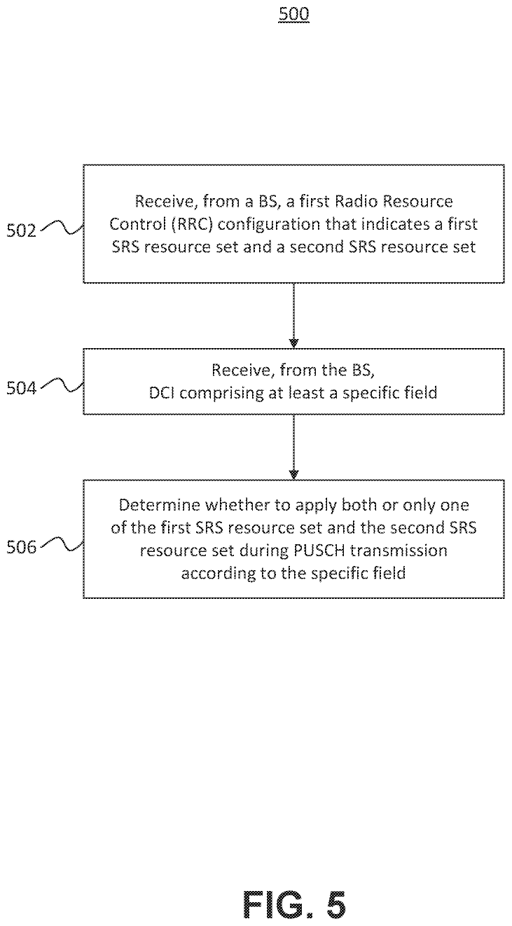

FIG. 5 is a flowchart illustrating a method/process 500 performed by a UE for UL transmission, according to an example implementation of the present disclosure. In action 502, the UE may receive from a BS, a first RRC configuration that indicates a first SRS resource set and a second SRS resource set. Action 502 in which the BS is configuring the SRS resource sets to the UE may be similar to action 112 illustrated in FIG. 1 and/or action 212 illustrated in FIG. 2. In some implementations, the first SRS resource set may be associated with a first TRP of the BS, and the second SRS resource set may be associated with a second TRP of the BS. The first TRP (also referred to as TRP #1) and the second TRP (also referred to as TRP #2) may correspond to different RRHs of the BS. The BS may configure the two SRS resource sets to the UE to facilitate multi-TRP based PUSCH transmissions. In some implementations, the UE may apply the first SRS resource set when performing the PUSCH transmission to the first TRP and apply the second SRS resource set when performing the PUSCH transmission to the second TRP.

In action 504, the UE may receive, from the BS, the DCI that includes at least a specific field. In some implementations, the specific field may be a dedicated field for providing the switching indication to the UE. For example, the specific field may indicate whether the UE performs single-TRP or multi-TRP based PUSCH transmissions. In some implementations, the specific field may further indicate a transmission order of the different TRPs. For example, the specific field may indicate whether the UE transmits the PUSCH to the first TRP first or the second TRP.

In action 506, the UE may determine whether to apply both or only one of the first SRS resource set and the second SRS resource set during the PUSCH transmission, according to the specific field. For example, the UE may apply both the first SRS resource set and the second SRS resource set in a case that the specific field indicates a multi-TRP based PUSCH transmission. On the other hand, the UE may apply one of the first SRS resource set and the second SRS resource set in a case that the specific field indicates a single-TRP based PUSCH transmission.

In some implementations, the UE may determine an order in which the first SRS resource set and the second SRS resource set are applied, according to the specific field in a case that both of the first SRS resource set and the second SRS resource set are applied during the PUSCH transmission. For example, the specific field may indicate the transmission order of the first TRP and the second TRP when multi-TRP based PUSCH transmission is performed. In some implementations, when multi-TRP based PUSCH transmission is enabled with repetitive transmissions, the transmission order may be one of {TRP #1, TRP #2, TRP #1, TRP #2}, {TRP #2, TRP #1, TRP #2, TRP #1}, {TRP #1, TRP #1, TRP #2, TRP #2}, and {TRP #2, TRP #2, TRP #1, TRP #1}. The specific field in the DCI may have 1 bit in some implementations or 2 bits in some other implementations.

In some implementations, the PUSCH transmission may be scheduled by the DCI. The DCI including the specific field may include a dynamic UL grant and may schedule the PUSCH transmission. The DCI may be a DCI format with CRC scrambled by a C-RNTI. The DCI may be DCI format 0_1 or DCI format 0_2.

In some implementations, the PUSCH transmission may be a CG PUSCH transmission configured by a CG configuration. For example, the CG PUSCH may be a Type 2 CG PUSCH, which may be configured via RRC signaling and activated/deactivated by the DCI. The CG configuration may indicate the periodicity of the CG PUSCH. CRC of the DCI may be scrambled by a CS-RNTI. The DCI may be a DCI format 0_1 or DCI format 0_2.

In some implementations, for a Type 2 CG PUSCH, the UE may receive, from the BS, a second RRC configuration that indicates a first power control related parameter associated with the first SRS resource set and a second power control related parameter associated with the second SRS resource set. The UE may activate the PUSCH transmission along with the second RRC configuration upon the reception of the DCI. Each of the first power control related parameter and the second power control related parameter may include at least one of the TPMI, SRI, and a transmission power indicator.

In some implementations, the number of the first SRS resources in the first SRS resource set may be identical to the number of the second SRS resources in the second SRS resource set. As such, the bit width of a first SRI field associated with the first SRS resource set may be identical to the bit width of a second SRI field associated with the second SRS resource set. The first SRI field and the second SRI field may be in the DCI or the CG configuration.

In some implementations, the DCI may further include a first TPMI field and a second TPMI filed. The first TPMI field may indicate first precoding information when applying the first SRS resource set during the PUSCH transmission, and the second TPMI field may indicate second precoding information when applying the second SRS resource set during the PUSCH transmission.

In some implementations, the same number of layers of precoding matrix may be applied to the first TPMI field and the second TPMI field. The first candidate TPMI values corresponding to the first TPMI field and the second candidate TPMI values corresponding to the second TPMI field may be based on the same TPMI table. The number of layers of precoding matrix may be derived from Table 4, as indicated above, in the present disclosure.

In some implementations, the second TPMI field may have fewer bits than the first TPMI field. The bit width of the second TPMI field may be related to the number of layers selected in the first TPMI field. For example, the number of layers indicated in the first TPMI field may be N, and the bit width of the second TPMI field may be ┌log₂(x)┐, where x may be the total amount of options based on the TPMI table associated with the first TPMI field and the number of layers is N.

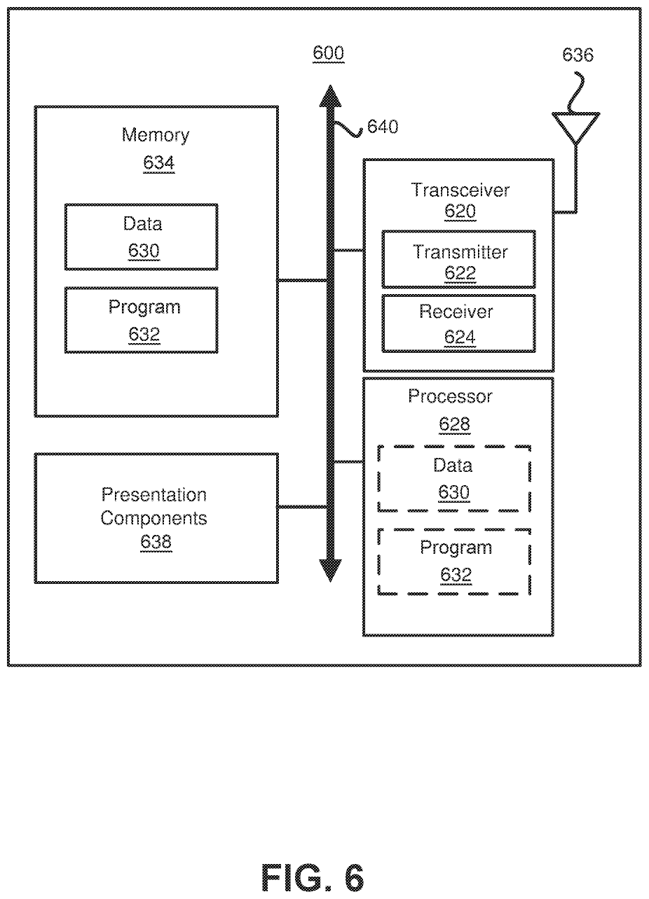

FIG. 6 is a block diagram illustrating a node 600 for wireless communication in accordance with various aspects of the present disclosure. As illustrated in FIG. 6, a node 600 may include a transceiver 620, a processor 628, a memory 634, one or more presentation components 638, and at least one antenna 636. The node 600 may also include a radio frequency (RF) spectrum band module, a BS communications module, a network communications module, and a system communications management module, Input/Output (I/O) ports, I/O components, and a power supply (not illustrated in FIG. 6).

Each of the components may directly or indirectly communicate with each other over one or more buses 640. The node 600 may be a UE or a BS that performs various functions disclosed with reference to FIGS. 1 through 5.

The transceiver 620 has a transmitter 622 (e.g., transmitting/transmission circuitry) and a receiver 624 (e.g., receiving/reception circuitry) and may be configured to transmit and/or receive time and/or frequency resource partitioning information. The transceiver 620 may be configured to transmit in different types of subframes and slots including but not limited to usable, non-usable and flexibly usable subframes and slot formats. The transceiver 620 may be configured to receive data and control channels.

The node 600 may include a variety of computer-readable media. Computer-readable media may be any available media that may be accessed by the node 600 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules or other data in a modulated data signal such as a carrier wave or other transport mechanisms and include any information delivery media.

The term “modulated data signal” may mean a signal that has one or more of its characteristics set or changed in such a manner as to encode information in the signal. Communication media may include wired media such as a wired network or direct-wired connection, and wireless media such as acoustic, RF, infrared and other wireless media. Combinations of any of the previously listed components should also be included within the scope of computer-readable media.

The memory 634 may include computer-storage media in the form of volatile and/or non-volatile memory. The memory 634 may be removable, non-removable, or a combination thereof. Example memory may include solid-state memory, hard drives, optical-disc drives, etc. As illustrated in FIG. 6, the memory 634 may store a computer-readable and/or computer-executable program 632 (e.g., software codes) that are configured to, when executed, cause the processor 628 to perform various functions disclosed herein, for example, with reference to FIGS. 1 through 5. Alternatively, the program 632 may not be directly executable by the processor 628 but may be configured to cause the node 600 (e.g., when compiled and executed) to perform various functions disclosed herein.

The processor 628 (e.g., having processing circuitry) may include an intelligent hardware device, e.g., a Central Processing Unit (CPU), a microcontroller, an ASIC, etc. The processor 628 may include memory. The processor 628 may process the data 630 and the program 632 received from the memory 634, and information transmitted and received via the transceiver 620, the base band communications module, and/or the network communications module. The processor 628 may also process information to send to the transceiver 620 for transmission via the antenna 636 to the network communications module for transmission to a CN.

One or more presentation components 638 may present data indications to a person or another device. Examples of presentation components 638 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for uplink (UL) transmission, the method comprising:
receiving, from a base station (BS), a first Radio Resource Control (RRC) configuration that indicates a first Sounding Reference Signal (SRS) resource set and a second SRS resource set;
receiving, from the BS, Downlink Control Information (DCI) comprising at least a specific field; and
determining whether to apply both or only one of the first SRS resource set and the second SRS resource set during Physical Uplink Shared Channel (PUSCH) transmission according to the specific field.

2. The method of claim 1, further comprising:
determining an order in which the first SRS resource set and the second SRS resource set are applied according to the specific field in a case that both of the first SRS resource set and the second SRS resource set are applied during the PUSCH transmission.

3. The method of claim 1, wherein:
the first SRS resource set is associated with a first Transmission Reception Point (TRP) of the BS; and
the second SRS resource set is associated with a second TRP of the BS.

4. The method of claim 1, wherein the PUSCH transmission is scheduled by the DCI.

5. The method of claim 1, wherein Cyclic Redundancy Check (CRC) of the DCI is scrambled by a Configured Scheduling-Radio Network Temporary Identifier (CS-RNTI).

6. The method of claim 5, further comprising:
receiving, from the BS, a second RRC configuration that indicates a first power control related parameter associated with the first SRS resource set and a second power control related parameter associated with the second SRS resource set; and
activating the PUSCH transmission along with the second RRC configuration upon reception of the DCI.

7. The method of claim 1, wherein a number of first SRS resources in the first SRS resource set is identical to a number of second SRS resources in the second SRS resource set.

8. The method of claim 1, wherein:
the DCI further includes a first Transmit Precoding Matrix Index (TPMI) field and a second TPMI field;
the first TPMI field indicates first precoding information when applying the first SRS resource set during the PUSCH transmission; and
the second TPMI field indicates second precoding information when applying the second SRS resource set during the PUSCH transmission.

9. The method of claim 8, wherein:
a same number of layers of precoding matrix is applied to the first TPMI field and the second TPMI field; and
first candidate TPMI values corresponding to the first TPMI field and second candidate TPMI values corresponding to the second TPMI field are based on a same TPMI table.

10. The method of claim 8, wherein the second TPMI field has fewer bits than the first TPMI field.

11. A user equipment (UE) for uplink (UL) transmission, the UE comprising:
one or more processors; and
at least one memory coupled to at least one of the one or more processors, wherein the at least one memory stores a computer-executable program that, when executed by the at least one of the one or more processors, causes the UE to:
receive, from a base station (BS), a first Radio Resource Control (RRC) configuration that indicates a first Sounding Reference Signal (SRS) resource set and a second SRS resource set;
receive, from the BS, Downlink Control Information (DCI) comprising at least a specific field; and
determine whether to apply both or only one of the first SRS resource set and the second SRS resource set during Physical Uplink Shared Channel (PUSCH) transmission according to the specific field.

12. The UE of claim 11, wherein the at least one processor is further configured to execute the computer-executable instructions to:
determine an order in which the first SRS resource set and the second SRS resource set are applied according to the specific field in a case that both of the first SRS resource set and the second SRS resource set are applied during the PUSCH transmission.

13. The UE of claim 11, wherein:
the first SRS resource set is associated with a first Transmission Reception Point (TRP) of the BS; and
the second SRS resource set is associated with a second TRP of the BS.

14. The UE of claim 11, wherein the PUSCH is scheduled by the DCI.

15. The UE of claim 11, wherein Cyclic Redundancy Check (CRC) of the DCI is scrambled by a Configured Scheduling-Radio Network Temporary Identifier (CS-RNTI).

16. The UE of claim 15, wherein the at least one processor is further configured to execute the computer-executable instructions to:
receive, from the BS, a second RRC configuration that indicates a first power control related parameter associated with the first SRS resource set and a second power control related parameter associated with the second SRS resource set; and
activate the PUSCH transmission along with the second RRC configuration upon reception of the DCI.

17. The UE of claim 11, wherein a number of first SRS resources in the first SRS resource set is identical to a number of second SRS resources in the second SRS resource set.

18. The UE of claim 11, wherein:
the DCI further includes a first Transmit Precoding Matrix Indicator (TPMI) field and a second TPMI field;
the first TPMI field indicates first precoding information when applying the first SRS resource set during the PUSCH transmission; and
the second TPMI field indicates second precoding information when applying the second SRS resource set during the PUSCH transmission.

19. The UE of claim 18, wherein:
a same number of layers of precoding matrix is applied to the first TPMI field and the second TPMI field; and
first candidate TPMI values corresponding to the first TPMI field and second candidate TPMI values corresponding to the second TPMI field are based on a same TPMI table.

20. The UE of claim 18, wherein the second TPMI field has fewer bits than the first TPMI field.
